(19) United States
(12) Patent Application Publication
(10) Pub. No.: US 2006/0101435 A1
(43) Pub. Date: May 11, 2006

(54) Detection of code patterns

(75) Inventors: Alex Akilov, Zichron Ya'akov (IL); Ronen Lerner, Haifa (IL); Sara Porat, Ramat Ishay (IL); Iftach Ragoler, Kibbutz Givat Brenner (IL); Avi Yaeli, D.N. Hof HaCarmel (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 10/964,389

(22) Filed: Oct. 13, 2004

(51) Int. Cl. G06F 9/45

(52) U.S. Cl. 717/141; 717/100

(57) ABSTRACT

A code pattern detector including at least one pattern definition expressed in a pattern language, and a code analyzer operative to employ the pattern definition to analyze a code base, the code analyzer including a representation builder operative to construct a representation of the code base, a pattern detector operative to process the representation in conjunction with the pattern definition to find a pattern within the representation, and an inference engine operative to express any of the found patterns as an abstract relationship within the code base.

### FIELD OF THE INVENTION

The present invention relates to the field of computer software analysis in general, and in particular to the detection of code patterns in software applications.

### BACKGROUND OF THE INVENTION

Computer software is typically composed of a “code base” of programs containing lines of code, written in a computer language such as Java® or C++, which are compiled and executed on a host computer. Software engineers often structure the code hierarchically by placing lines of code in methods that are nested in classes, which are distributed among files. Software applications themselves may be organized into hierarchies, where low-level applications communicate between themselves on the same or different host computers under the control of a high-level application. Understanding the underlying structure of a distributed software system is a valuable tool in maintaining these complex systems.

A top down approach may be used to determine the structure of a code base based on the assumption that the code base was constructed in a structured manner. For example, high-level modeling languages, such as UML, enable software architects to design a well-structured software system. Moreover, the modeling language may even generate the low-level code, such as C++ code. However, this approach requires that the high-level representation be continuously synchronized with the low-level code, should changes be introduced in the low-level code. This is something that is difficult to do in practice.

Alternatively, a bottom up approach may be used to determine the code structure by analyzing the low-level code directly and attempting to detect patterns in the code based on a set of pre-defined heuristics. For example, code dependencies may be found by detecting static references to methods and variables in the code, so that when a usage of a variable appears in multiple program files, it may indicate a dependency between those program files. However, this approach is not well suited for determining the overall code structure, typically due to subtle complex relationships between segments of code, such as function call invocations that depend on certain variable values.

Some dependencies are relatively easy to discover, such as when one component invokes a method of another component, or when component relationships are defined in a deployment descriptor. Other dependencies are more complicated and less direct, such as when a relationship is result of a sequence of calls, such as in a call pattern, in a module's code that infers additional indirect dependencies. In J2EE, for example, modules communicate though their containers. When one EJB wants to access another EJB, it invokes the lookup method on a javax.naming.Context object. If the lookup invocation is found, assuming that the EJB name that is associated with that JNDI name can be resolved, it can be inferred that these two EJBs are communicating and that there is a dependency between them. In this example, the pattern to be found is a single instruction—the lookup invocation. In other situations, the code pattern is more complex, involving a sequence of method invocations. In fact, to more correctly identify an EJB lookup, it is better to also look for an RMI narrow invocation following the lookup invocation, since a lookup can be for any type of component, such as data source, and not just an EJB.

It would be advantageous to define an inference engine that takes not only the found patterns into consideration, but also other environmental and domain information, such as deployment descriptors, environment variables, etc., such that other high-level relationships might then be deduced for study by the programmer.

### SUMMARY OF THE INVENTION

The present invention discloses a system and method for defining code patterns and for searching for the patterns in a code base.

In one aspect of the present invention a code pattern detector is provided including at least one pattern definition expressed in a pattern language, and a code analyzer operative to employ the pattern definition to analyze a code base, the code analyzer including a representation builder operative to construct a representation of the code base, a pattern detector operative to process the representation in conjunction with the pattern definition to find a pattern within the representation, and an inference engine operative to express any of the found patterns as an abstract relationship within the code base.

In another aspect of the present invention the code analyzer is operative to employ the pattern definition to analyze the code base and create at least one inference therefrom.

In another aspect of the present invention the code pattern detector further includes an operand resolver operative to resolve a value of any variables in the code base related to any of the patterns found within the representation.

In another aspect of the present invention the pattern definition describes a potential dependency in the code base.

In another aspect of the present invention the representation builder is operative to emulate the execution environment of the code base and express the representation as any of a call graph, a control flow graph, a cross language dependency graph, and a data flow graph.

In another aspect of the present invention the pattern definition defines a sequence of instructions and at least one relationship between any of the instructions.

A code pattern detector according to claim 6 where the pattern definition is constructed as a set of tags within a document.

In another aspect of the present invention the pattern definition is constructed as a set of XML tags within an XML document.

In another aspect of the present invention the tags include at least one parent tag that defines an instruction sequence, and at least one child tag that defines either of a characteristic of the instruction sequence and a characteristic of any of the instructions within the instruction sequence.

In another aspect of the present invention the relationship is a control flow relationship describing the order in which instructions are executed.

In another aspect of the present invention the relationship is a data flow relationship describing the flow and manipulation of data between two instructions in the instruction sequence.

In another aspect of the present invention the representation is a control flow graph, and where the pattern detector is operative to search the control flow graph to verify a sequence of instruction specified by the pattern definition.

In another aspect of the present invention the pattern detector is operative to verify that a data flow in the pattern definition corresponds to a data flow detected in the found pattern.

In another aspect of the present invention the operand resolver is operative to determine from the pattern definition which of the variables to resolve, determine from the pattern definition a scope for any of the variables, determine which segment of the code base to emulate based on the found pattern, and resolve any of the variables.

In another aspect of the present invention the operand resolver is operative to resolve any of the variables by emulating a segment of the code base corresponding to the variable, and create a resolved pattern therewith.

In another aspect of the present invention the code analyzer is operative to identify a relationship between a source including the code base, a configuration file, and the resolved pattern, and a target.

In another aspect of the present invention a method is provided for detecting a code pattern, the method including expressing at least one pattern definition in a pattern language, constructing a representation of a code base, processing the representation in conjunction with the pattern definition to find a pattern within the representation, and expressing any of the found patterns as an abstract relationship within the code base.

In another aspect of the present invention the method further includes resolving a value of any variables in the code base related to any of the patterns found within the representation.

In another aspect of the present invention the first expressing step includes describing a potential dependency in the code base.

In another aspect of the present invention the constructing step includes emulating the execution environment of the code base and express the representation as any of a call graph, a control flow graph, a cross language dependency graph, and a data flow graph.

In another aspect of the present invention the first expressing step includes defining a sequence of instructions and at least one relationship between any of the instructions.

In another aspect of the present invention the first expressing step includes constructing the pattern definition as a set of tags within a document.

In another aspect of the present invention the first expressing step includes constructing the pattern definition as a set of XML tags within an XML document.

In another aspect of the present invention the first expressing step includes constructing the pattern definition using at least one parent tag that defines an instruction sequence, and at least one child tag that defines either of a characteristic of the instruction sequence and a characteristic of any of the instructions within the instruction sequence.

In another aspect of the present invention the first expressing step includes defining a control flow relationship describing the order in which instructions are executed.

In another aspect of the present invention the first expressing step includes defining a data flow relationship describing the flow and manipulation of data between two instructions in the instruction sequence.

In another aspect of the present invention the constructing step includes constructing a control flow graph, and where the processing step includes searching the control flow graph to verify a sequence of instruction specified by the pattern definition.

In another aspect of the present invention the processing step includes verifying that a data flow in the pattern definition corresponds to a data flow detected in the found pattern.

In another aspect of the present invention the resolving step includes determining from the pattern definition which of the variables to resolve, determining from the pattern definition a scope for any of the variables, determining which segment of the code base to emulate based on the found pattern, and resolving any of the variables.

In another aspect of the present invention the resolving step includes resolving any of the variables by emulating a segment of the code base corresponding to the variable, and creating a resolved pattern therewith.

In another aspect of the present invention the method further includes identifying a relationship between a source including the code base, a configuration file, and the resolved pattern, and a target.

In another aspect of the present invention a computer program is provided embodied on a computer-readable medium, the computer program including a first code segment operative to employ a pattern definition expressed in a pattern language to analyze a code base, a second code segment operative to construct a representation of the code base, a third code segment operative to process the representation in conjunction with the pattern definition to find a pattern within the representation, and a fourth code segment operative to express any of the found patterns as an abstract relationship within the code base.

### BRIEF DESCRIPTION OF THE DRAWINGS

The present invention will be understood and appreciated more fully from the following detailed description taken in conjunction with the appended drawings in which:

FIG. 1A is a simplified pictorial illustration of a code pattern detector, constructed and operative in accordance with a preferred embodiment of the present invention;

FIG. 1B is a simplified flowchart illustration of a method for detecting code patterns, operative in accordance with a preferred embodiment of the present invention;

FIG. 2 is a simplified example of a code base and pattern definition, constructed and operative in accordance with a preferred embodiment of the present invention;

FIG. 3A is a simplified illustration of a method for construction and analysis of representative data, operative in accordance with a preferred embodiment of the present invention;

FIG. 3B is a simplified pictorial illustration of an example call flow, constructed and operative in accordance with a preferred embodiment of the present invention;

FIG. 4 is a simplified illustration of a method for resolving operands, operative in accordance with a preferred embodiment of the present invention;

FIG. 5A is a simplified illustration of a method for constructing a relationship between a source and a target artifact, operative in accordance with a preferred embodiment of the present invention; and

FIG. 5B is a simplified illustration of an exemplary inference from code patterns, operative in accordance with a preferred embodiment of the present invention.

### DETAILED DESCRIPTION OF PREFERRED EMBODIMENTS

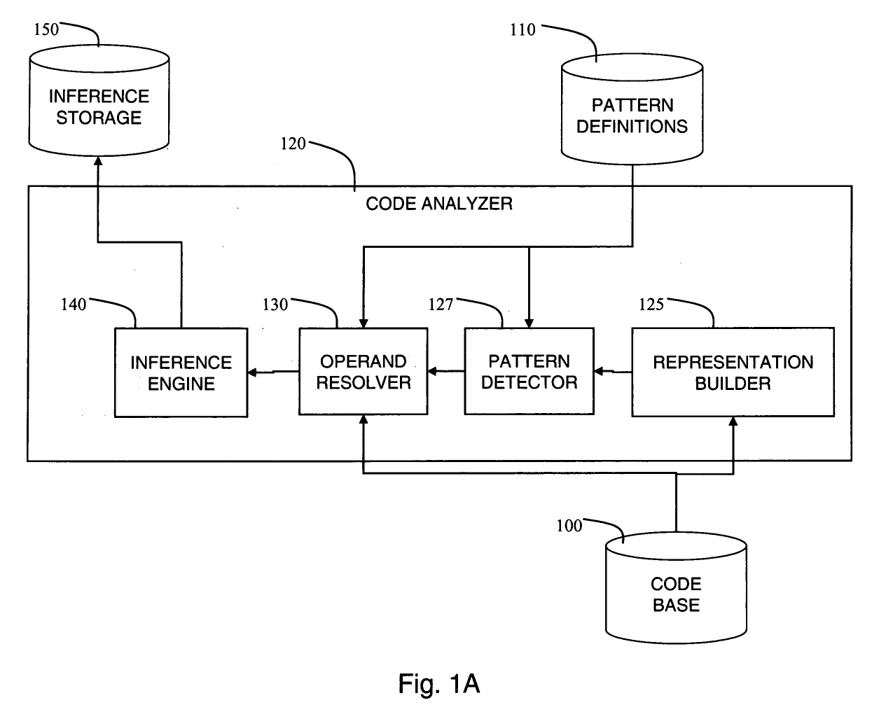

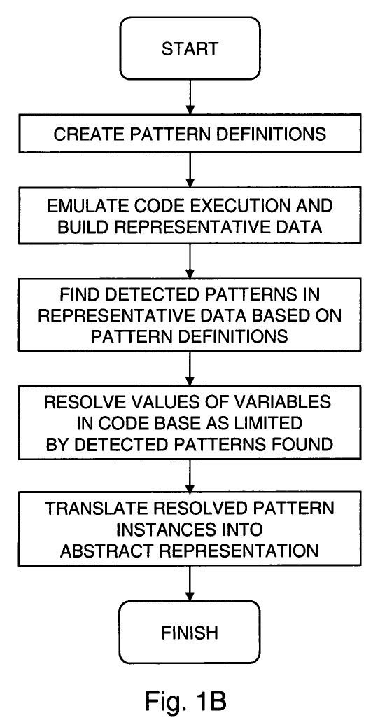

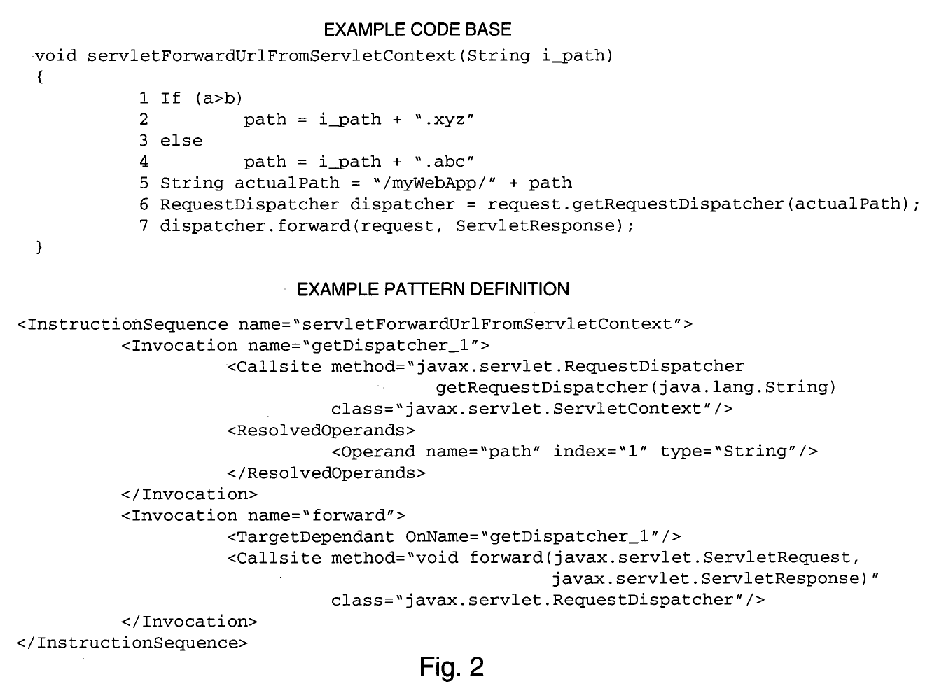

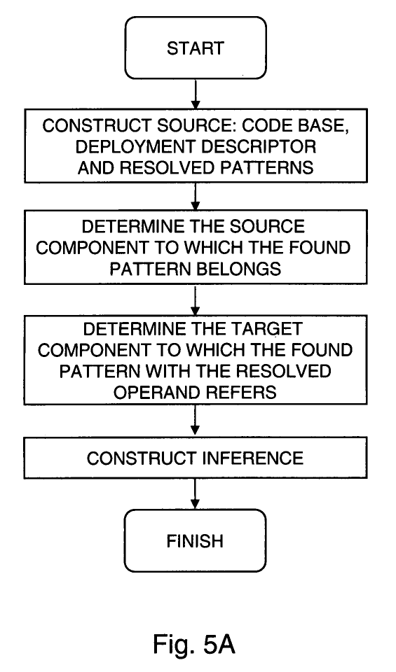

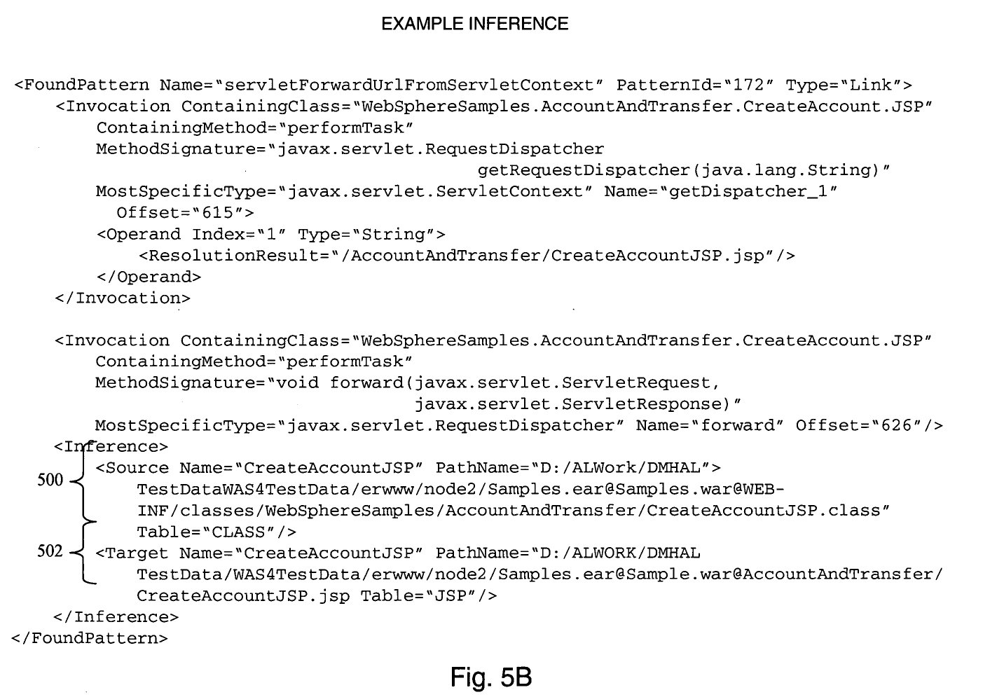

Reference is now made to FIG. 1A, which is a simplified pictorial illustration of a code pattern detector, constructed and operative in accordance with a preferred embodiment of the present invention, and to FIG. 1B, which is a simplified flowchart illustration of a method for detecting code patterns, operative in accordance with a preferred embodiment of the present invention. In FIG. 1A a code base 100 is shown including software to be analyzed, to which a set of pattern definitions 110 expressed in a pattern language, described with more detail hereinbelow with reference to FIGS. 2 and 5, which describes potential dependencies in code base 100. Code base 100 may include any type of program representation, such as source code, binary code, intermediate code, and program model representations. A code analyzer 120 employs pattern definitions 110 to analyze code base 100 and may create a set of inferences that may be utilized for further analysis. For example, the inferences may be employed to introduce the code to a new software engineer.

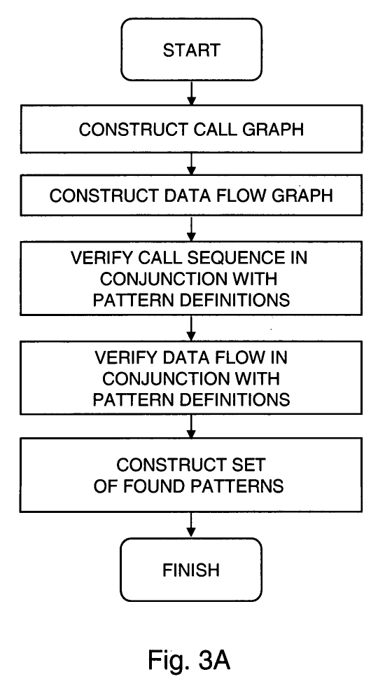

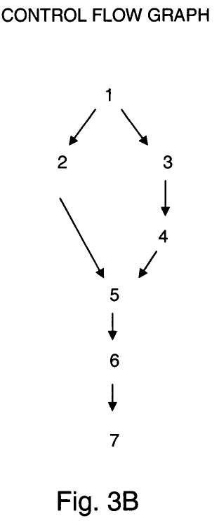

Code analyzer 120 preferably employs a representation builder 125 to construct a representation of code base 100. Representation builder 125 preferably emulates the execution environment of code base 100 and constructs representative data, such as a call graph, control flow, and data flow. Such representative data are described in more detail below with reference to FIGS. 2, 3A and 3B. A pattern detector 127 preferably processes the representative data in conjunction with pattern definitions 110 to find patterns within the representative data, such as segments of the call flow that may be subject to further analysis by code analyzer 120. Code analyzer 120 may further utilize an operand resolver 130 to resolve possible values of variables. Operand resolver 130 typically operates on segments of code base 100 associated with the detected patterns found within the representative data. The scope of the variables to be resolved is typically defined in pattern definitions 110, as described in greater detail hereinbelow with reference to FIG. 2. The resolved pattern is preferably utilized by an inference engine 140 to infer 1 abstract relationships that may exist in code base 100, as is described in greater detail hereinbelow with reference to FIG. 5A. The abstract relationships may then be stored in an inference storage 150 for future analysis or presentation to individuals who may make use of such information.

Reference is now made to FIG. 2, which is a simplified example of a code base and pattern definition, operative in accordance with a preferred embodiment of the present invention. FIG. 2 shows various pattern definitions that define a sequence of computer language instructions and the instruction relationships, such as the control flow and data flow relationships. Pattern definitions may be constructed as a set of tags within a document, such as XML tags within an XML document, that typically include parent tags that define an instruction sequence, and child tags that define characteristics of the instruction sequence, such as data flow or control flow, and/or characteristics of the instructions within the instruction sequence, such as the type of invoked instructions within the code base as well as the indices of operands to resolve.

Control flow relationships typically describe the order in which instructions are executed, are typically defined within the space of all execution paths, and need not be limited in their scope to a flow of control as ascertained through textual analysis of code base 100, but may be a function of actual execution flow as well. For example, a pattern definition that describes a control flow may include a prioritization of the control flow, such as by specifying that a first instruction must be executed prior to a second instruction.

Data flow relationships typically describe the flow and manipulation of data between two instructions in an instruction sequence. A sequence of instructions may have an inherent value chain with respect to the data flow, where certain instructions when executed prior to others may build value in the data. For example, given two invocations:
D1_F1(P1, P2) { . . . }
   and
D2_F2(P3) { . . . }
   where D1_F1(P₁, P₂) creates data D1 and requires parameters P₁ and P₂, and D2_F2(P₃) creates data D2 and requires a parameter P₃, the sequence of invocations:
D2_F2(D1_F1(P1, P2))
   is a legitimate statement assuming that D1 is of type appropriate for the parameter of F2( ). In this sequence the data is first constructed in F1( ) and then flows from F1( ) to F2( ) as a parameter in F2( ). Thus, the value chain of the data D1 can be described as a sequential value chain where the value is built leading from F1( ) to F2( ).

Numerous data flows may exist and may be particular to the programming language employed. For example, in the Java® language, the following six types of data flow may be identified:
1. The receiver object of a second invocation is the return object of the first invocation: (Return Object→Receiver Object)
   e.g.,

b=a.foo( )

b.bar( )
2. The receiver object of a second invocation is the receiver object of the first invocation: (Receiver Object→Receiver Object)
   e.g.,

a.foo( )

a.bar( )
3. The receiver object of a second invocation is one of the parameters of the first invocation: (Parameter→Receiver Object)
   e.g.,

a.foo(c,d)

c.bar( )
4. The parameter of the second invocation is the return object of the first invocation: (Return Object→Parameter)
   e.g.,

c=a.foo( )

b.bar(c,d)
5. One of the parameters of a second invocation is the receiver object of first invocation: (Receiver Object→Parameter)
   e.g.,

a.foo( )

b.bar(a,d)
6. Parameter of second invocation is parameter of first invocation: (Parameter→Parameter)
   e.g.,

a.foo(c,d)

b.bar(c,e)

Preferably, the pattern language provides a mechanism for describing all possible code dependencies, such as those described hereinabove.

In the example shown in FIG. 2, code base 100 includes code that instructs a Java® Virtual Machine to forward an HTTP request to a secondary destination. Pattern definitions 110 includes the pattern definition shown in FIG. 2 that describes a pattern in code base 100, which indicates to code analyzer 120 that code base 100 includes a single instruction sequence, delimited by the <InstructionSequence> tag, with two invocations, defined by the <Invocation> tags. Furthermore, the first invocation includes a variable ‘path’ that should be resolved by operand resolver 130, as specified by the <ResolvedOperands> tag.

The control flow shown in the pattern definition of FIG. 2 is implicitly defined by the sequence of the <Invocation> tags, such that the invocation ‘getDispatcher_{—}1’ is specified by the pattern definition to occur prior to the invocation ‘forward.’

A portion of the data flow shown in the code base of FIG. 2, is reproduced below, and corresponds to the first template described hereinabove, as follows:
RequestDispatcher dispatcher=request.getRequestDispatcher(actualPath); dispatcher.forward(request, ServletResponse);
   This corresponds to:

(Return Object→Receiver Object)

e.g.,

b=a.foo( )

b.bar( )

The data flow in this example is defined using the <TargetDependent> tag, which defines which invocation built the data before the data is used as a Receiver object for the current invocation. In our example, the “forward” invocation is target-dependent on the “get_Dispatcher1” invocation.

Pattern definitions may include any combination of instruction relationships, including a combined control and data flow relationship between instructions, such as where a first instruction is executed prior to a second instruction and the data of the second instruction is constructed using the result of the first instruction.

Reference is now made to FIG. 3A, which is a simplified illustration of a method for construction and analysis of representative data, operative in accordance with a preferred embodiment of the present invention, and to FIG. 3B, which is a simplified pictorial illustration of an example call flow, constructed and operative in accordance with a preferred embodiment of the present invention. In FIG. 3A, representation builder 125 preferably emulates the execution environment of code base 100 and constructs representative data, such as a call graph, a control flow graph, a cross language dependency graph and a data flow graph. Pattern detector 127 preferably searches for patterns in the representative data in conjunction with pattern definition 110, such as by searching the control flow graph to verify the sequence of instruction as specified by the pattern definition 127, such as by verifying that a first instruction is invoked prior to a second instruction, or by searching the data flow graph to verify that data created in a first invocation is further used in a second invocation.

For example, given the code base and pattern definition shown in FIG. 2 code analyzer 120 may do the following. First, representation builder 125 may construct the control flow graph shown in FIG. 3B, which describes two possible call flows {1,2,5,6,7} and {1,3,4,5,6,7}. Next, pattern detector 127 may search the control flow graph to verify the patterns described in the pattern definition. For example, the pattern definition in FIG. 2 specifies that invocation ‘get_Dispatcher_{—}1’ corresponding to line 6 of code base 100 should occur prior to the invocation ‘forward’ corresponding to line 7 of code base 100. Thus, pattern detector 127 may first search for all call flows that include lines 6 and 7, and then verify that line 6 appears prior to line 7 in the call flows. The Pattern Detector 127 will verify that the data flow in the pattern definition corresponds to the data flow detected in the found pattern. Pattern detector 127 preferably constructs a set of detected patterns among the instruction sequences in code base 100 that correspond to instruction sequences specified in pattern definitions 110, which may be further processed by operand resolver 130.

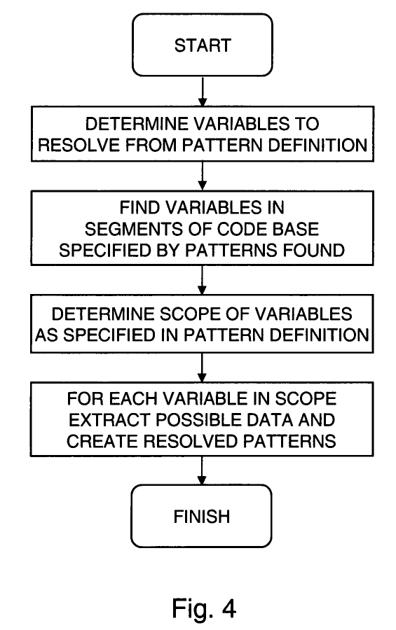

Reference is now made to FIG. 4, which is a simplified illustration of a method for resolving operands, operative in accordance with a preferred embodiment of the present invention. Variables are often employed within a code base that may hide instructions and instruction relationships. For example, the following code snippet describes a conditional data flow relationship:

```
if (a>b)
  value = “myServlet1”;
else
  value = “myServlet2”;
RequestDispatcher dist = myRequest.getRequestDispatcher(value);
dist.include(myRequest, myResponse);
```

In this example, the data embedded in the object ‘dist’ is primed with information retrieved from the object ‘myRequest’ dependant on the data in the object ‘value’. Thus, while the value chain of the data starts with ‘value’, goes through ‘myRequest’, and ends with ‘dist’, the value chain is conditional on variables ‘a’ and ‘b’. In some cases the value is important as it defines the pattern role. In the present example it is the target Servlet to be invoked. Operand resolver 130 preferably detects all the variables that may affect the value chain and determines possible value chains for these variables. In the example presented hereinabove, operand resolver 130 may build a value chain for ‘a>b’ and for ‘a<b’, and consequently build the following two value chains:

VALUE CHAIN 1
RequestDispatcher dist = myRequest.getRequestDispatcher
(“myServlet1”);
dist.include(myRequest, myResponse);
VALUE CHAIN 2
RequestDispatcher dist = myRequest.getRequestDispatcher
(“myServlet2”);
dist.include(myRequest, myResponse);

Operand resolver 130 may conclude that there are two possible values in the getRequestDispatcher invocation, “myServlet1” and “myServlet2”.

Operand resolver 130 preferably determines which variables to resolve as well as their scope, or the valid value ranges for the variable, from pattern definition 110. Next, operand resolver 130 may determine which segment of code base 100 to emulate based on the detected patterns found by pattern detector 127, as described hereinabove. Finally, operand resolver 130 resolves the variables, typically by emulating the relevant segment of code base 100, to create a set of resolved patterns. A resolved pattern may take the form of a detected pattern realized within a particular solution space of a variable. For example, an invocation may access one of two types of documents dependent on the value of a variable, such as the invocation on line 6 shown in FIG. 2 that may access a document of type ‘xyz’ or ‘abc’ dependent on the value of the variable ‘path’. Whereas pattern detector 127 may locate a detected pattern, such as the control flow from line 6 to line 7 shown in FIG. 2 and described hereinabove, operand resolver 130 is preferably capable of locating a resolved pattern that indicates the type of document that is accessed.

Reference is now made to FIG. 5A, which is a simplified illustration of a method for constructing a relationship between a source and a target artifact, operative in accordance with a preferred embodiment of the present invention, and FIG. 5B, which is a simplified illustration of an exemplary inference from code patterns, operative in accordance with a preferred embodiment of the present invention. In FIG. 5A, software including a code base, a configuration file, such as a deployment descriptor, and the resolved patterns found by operand resolver 130, may have an “abstract” relationship with a target artifact, such as a table in a relational database. An abstract relationship is defined as a relationship between an element and a member of a set of other elements, where the specific relationship between the element and the member may be resolved differently in different circumstances. For example, the element whichTable may have an abstract relationship with a database manyTables having many tables, where the value of whichTable, namely which table is currently being pointed to, may vary at different times. As described hereinabove, code analyzer 120 analyzes code base 100 in conjunction with pattern definitions 110 to create inferences that describe the structure of code base 100. In addition, code analyzer 120 may also find other relationships within code base 100. In the example shown in FIG. 5B, an analysis by code analyzer 120 of the code base and pattern definition shown in FIG. 2 results in a single relationship, delimited with the <FoundPattern> tag. A traversal by inference engine 140 of the resolved patterns, as described hereinabove with reference to FIG. 3A, 3B and FIG. 4, results in a single inference delimited by the <Inference> tag. The inference indicates that a relationship may exist between a source function and target function, where in this example the source may be a Java® Servlet and the target an Enterprise JavaBean®. In FIG. 5B, reference numeral 500 indicates the found source class in which a pattern was found, whereas reference numeral 502 indicates the target JSP to which the Servlet ‘forward’ dispatches the request.

In another example, given software that includes the following code base:

```
if (a<b)
  table = “FirstTable”;
else
  table = “SecondTable”;
Connection = context.lookup(“MyData”);
Connection.open( );
Statement = Connection.getStatement( );
Statement.execute(“SELECT * FROM “ + table);
```

and a deployment description that includes a configuration file with the following properties:
DatabaseContext=ODBC:Source
   and assuming that operand resolver 130 is limited in scope to situation where (a>b), code analyzer 120 may find the following resolved patterns:
ODBC:Source:MyData:SELECT*FROM SecondTable
   indicating a relationship between the source, being code base 100, the deployment descriptor, and the resolved pattern, with the target, being SecondTable in database MyData, accessible via ODBC:Source.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A code pattern detector comprising:
at least one pattern definition expressed in a pattern language; and
a code analyzer operative to employ said pattern definition to analyze a code base, said code analyzer comprising:
a representation builder operative to construct a representation of said code base;
a pattern detector operative to process said representation in conjunction with said pattern definition to find a pattern within said representation; and
an inference engine operative to express any of said found patterns as an abstract relationship within said code base.

2. A code pattern detector according to claim 1 wherein said code analyzer is operative to employ said pattern definition to analyze said code base and create at least one inference therefrom.

3. A code pattern detector according to claim 1 and further comprising an operand resolver operative to resolve a value of any variables in said code base related to any of said patterns found within said representation.

4. A code pattern detector according to claim 1 wherein said pattern definition describes a potential dependency in said code base.

5. A code pattern detector according to claim 1 wherein said representation builder is operative to emulate the execution environment of said code base and express said representation as any of a call graph, a control flow graph, a cross language dependency graph, and a data flow graph.

6. A code pattern detector according to claim 1 wherein said pattern definition defines a sequence of instructions and at least one relationship between any of said instructions.

7. A code pattern detector according to claim 6 wherein said pattern definition is constructed as a set of tags within a document.

8. A code pattern detector according to claim 7 wherein said pattern definition is constructed as a set of XML tags within an XML document.

9. A code pattern detector according to claim 7 wherein said tags include at least one parent tag that defines an instruction sequence, and at least one child tag that defines either of a characteristic of said instruction sequence and a characteristic of any of said instructions within said instruction sequence.

10. A code pattern detector according to claim 6 wherein said relationship is a control flow relationship describing the order in which instructions are executed.

11. A code pattern detector according to claim 6 wherein said relationship is a data flow relationship describing the flow and manipulation of data between two instructions in said instruction sequence.

12. A code pattern detector according to claim 1 wherein said representation is a control flow graph, and wherein said pattern detector is operative to search said control flow graph to verify a sequence of instruction specified by said pattern definition.

13. A code pattern detector according to claim 1 wherein said pattern detector is operative to verify that a data flow in said pattern definition corresponds to a data flow detected in said found pattern.

14. A code pattern detector according to claim 3 wherein said operand resolver is operative to:
determine from said pattern definition which of said variables to resolve,
determine from said pattern definition a scope for any of said variables,
determine which segment of said code base to emulate based on said found pattern, and
resolve any of said variables.

15. A code pattern detector according to claim 3 wherein said operand resolver is operative to resolve any of said variables by emulating a segment of said code base corresponding to said variable, and create a resolved pattern therewith.

16. A code pattern detector according to claim 15 wherein said code analyzer is operative to identify a relationship between a source comprising said code base, a configuration file, and said resolved pattern, and a target.

17. A method for detecting a code pattern, the method comprising:
expressing at least one pattern definition in a pattern language;
constructing a representation of a code base;
processing said representation in conjunction with said pattern definition to find a pattern within said representation; and
expressing any of said found patterns as an abstract relationship within said code base.

18. A method according to claim 17 and further comprising resolving a value of any variables in said code base related to any of said patterns found within said representation.

19. A method according to claim 17 wherein said first expressing step comprises describing a potential dependency in said code base.

20. A method according to claim 17 wherein said constructing step comprises emulating the execution environment of said code base and express said representation as any of a call graph, a control flow graph, a cross language dependency graph, and a data flow graph.

21. A method according to claim 17 wherein said first expressing step comprises defining a sequence of instructions and at least one relationship between any of said instructions.

22. A method according to claim 21 wherein said first expressing step comprises constructing said pattern definition as a set of tags within a document.

23. A method according to claim 22 wherein said first expressing step comprises constructing said pattern definition as a set of XML tags within an XML document.

24. A method according to claim 22 wherein said first expressing step comprises constructing said pattern definition using at least one parent tag that defines an instruction sequence, and at least one child tag that defines either of a characteristic of said instruction sequence and a characteristic of any of said instructions within said instruction sequence.

25. A method according to claim 21 wherein said first expressing step comprises defining a control flow relationship describing the order in which instructions are executed.

26. A method according to claim 21 wherein said first expressing step comprises defining a data flow relationship describing the flow and manipulation of data between two instructions in said instruction sequence.

27. A method according to claim 17 wherein said constructing step comprises constructing a control flow graph, and wherein said processing step comprises searching said control flow graph to verify a sequence of instruction specified by said pattern definition.

28. A method according to claim 17 wherein said processing step comprises verifying that a data flow in said pattern definition corresponds to a data flow detected in said found pattern.

29. A method according to claim 18 wherein said resolving step comprises:
determining from said pattern definition which of said variables to resolve,
determining from said pattern definition a scope for any of said variables,
determining which segment of said code base to emulate based on said found pattern, and
resolving any of said variables.

30. A method according to claim 18 wherein said resolving step comprises resolving any of said variables by emulating a segment of said code base corresponding to said variable, and creating a resolved pattern therewith.

31. A method according to claim 30 and further comprising identifying a relationship between a source comprising said code base, a configuration file, and said resolved pattern, and a target.

32. A computer program embodied on a computer-readable medium, the computer program comprising:
a first code segment operative to employ a pattern definition expressed in a pattern language to analyze a code base;
a second code segment operative to construct a representation of said code base;
a third code segment operative to process said representation in conjunction with said pattern definition to find a pattern within said representation; and
a fourth code segment operative to express any of said found patterns as an abstract relationship within said code base.
